(19) United States
(12) Patent Application Publication
(10) Pub. No.: US 2022/0001584 A1
(43) Pub. Date: Jan. 6, 2022

(54) Method for Producing a Surface Heater for a Sub-Region of a Vehicle

(71) Applicant: Bayerische Motoren Werke Aktiengesellschaft, Muenchen (DE)

(72) Inventors: Johannes HUBER, Pfeffenhausen (DE); Martin SCHNEEBAUER, Muenchen (DE)

(21) Appl. No.: 17/283,803

(22) PCT Filed: Nov. 20, 2019
(86) PCT No.: PCT/EP2019/081862

§ 371 Date: Apr. 8, 2021

(30) Foreign Application Priority Data
Dec. 17, 2018 (DE) 10 2018 132 395.6

(51) Int. Cl. B29C 45/16; H05B 3/28

(52) U.S. Cl. CPC B29C 45/1671; B29C 2045/14237; H05B 3/286

(57) ABSTRACT

A method for producing a surface heater for heating a sub-region of a vehicle includes a first step, a second step, a third step, and a fourth step. The first step includes arranging heating wires on a film and either: i) the film is subsequently formed to a predefined shape, or ii) providing a film which has been formed to a predefined shape. The second step includes inserting the formed film into an injection-molding tool. The heating wires point either toward the wall or into the hollow space of the injection-molding tool. The third step includes overmolding with a predefined material. The fourth step includes applying a transparent lacquer layer to the finished injection-molded part.

### BACKGROUND AND SUMMARY OF THE INVENTION

The disclosure relates to a method for producing a surface heater for a sub-region of a vehicle.

The integration of a surface heater in an exterior component of a vehicle for increasing the availability of sensor systems, in particular radar (FRR, MRR), is known. Wound heaters or laid wire scrims on films are known, which are then further processed in an injection-molding process. In the case of wound heaters, a wire having a diameter of approximately 0.3-0.4 mm is wound onto a so-called preform and contact-connected with a connector. The modified preform is subsequently inserted into an injection-molding tool and overmolded. In the case of a film-based heater, a wire having a diameter of 0.03-0.2 mm is laid along the area to be heated by means of a wire-laying process. Subsequently, the heater is overmolded in an injection-molding process and a region for contacting points is omitted.

On account of the required wire thicknesses and the winding geometry, wound heaters are not suitable for areas with high surface requirements since accumulations of mass in the injection molding result in problems with sink marks and surface imperfections. Furthermore, the distance between the heating element (wire) and the surface to be heated is too great to ensure rapid response behavior of the heater, for example for defrosting. In the case of film-based heaters, relatively low wire thicknesses can be used for the heater, with the result that the wire does not visibly stand out toward the outside. In general, the film-based heater is inserted with the wire side pointing toward the plastics constituent in the injection-molding tool, and the wire side is overmolded. There is the risk here of the wire being displaced by the melt. A further problem is the heating merely of a sub-region for example of a front panel of a vehicle with a film, since the film edges may stand out here.

It is an object of this disclosure to provide a production method of a surface heater for heating a sub-region of a vehicle, said method making improved response behavior of the heater, and also visual integration in an exterior component, possible.

The object is achieved by way of the features disclosed herein. It is pointed out that additional features of a patent claim which is dependent on an independent patent claim can, without the features of the independent patent claim or only in combination with a subset of the features of the independent patent claim, form a stand-alone invention which is independent of the combination of all features of the independent patent claim, which stand-alone invention can be made the subject of an independent claim, of a divisional application or of a subsequent application. This applies in the same way to technical teachings given in the description, which can form an invention which is independent of the features of the independent patent claims.

A method for producing a surface heater for heating a sub-region of a vehicle is proposed, wherein, in a first step, heating wires are arranged on a film and the film is subsequently formed to a predefined shape. Alternatively, a film which has already been formed to a predefined shape can be provided. In a second step, the formed film is inserted into an injection-molding tool, wherein the heating wires point either toward the wall or into the hollow space of the injection-molding tool. In a third step, an overmolding operation is performed with a predefined material. In a fourth step, a transparent lacquer layer is applied to the finished injection-molded part.

This production method, in particular the use of the transparent lacquer layer, makes it possible to realize low layer thicknesses without relatively large shear forces, which leads to increased process safety during the overmolding. It is also possible for the surface heater to be brought closer to the surface to be heated, for example the radar sensor. It is thus the case that the energy requirement is lowered, and the response behavior of the surface heater is improved. The application of the transparent lacquer layer to the surface heater, more specifically to the film with the heating wires, for example by way of flooding, also makes it possible to conceal or cover visible film edges.

Furthermore, provision is made for the thickness of the total layered composite composed of film with heating wires, material and lacquer layer to in this case lie between 2 mm and 7 mm, and advantageously be a multiple of half the wavelength of the radar beams in the material.

Furthermore, provision is made for the thickness of the lacquer layer in the fourth step to be selected in such a way that the heating wires are completely embedded in the material. This applies both in the case when the heating wires, after insertion into the injection-molding tool in the second step, point into the hollow space of the injection-molding tool and in the case when they point toward the injection-molding tool. Provision is advantageously made for the transparent lacquer layer to have a thickness of between 0.2 mm and 1.0 mm, advantageously approximately 0.7 mm, depending on the type of heating wires and arrangement in the injection-molding tool.

Depending on whether the heating wires point into the hollow space or toward the wall of the injection-molding tool during the insertion in the second step, the thickness of the transparent lacquer layer can be selected in a correspondingly thin manner in the fourth step. A surface is thus generated in the case of which the heating wires do not stand out on the surface.

Furthermore, provision is made for the lacquer layer to be applied in the tool by means of flooding. Flooding with the lacquer layer makes it possible to achieve uniform coverage. It is advantageous if the injection-molding tool is rotatable and is rotated together with the injection-molded part after the third step, such that the transparent lacquer layer can be applied in the fourth step. The coating process can thus be shortened.

Furthermore, provision is made for the formed film to occupy merely a sub-region of the injection-molding tool. Advantageously, the heating wires have been or are colored at least in sub-regions, advantageously over the entire area, in the color of the material. Advantageously, in the third step, the overmolding operation is performed with the predefined material in such a way that a structured surface with a predefined structure is generated. Since the film heater occupies merely a part of the injection-molding tool, the associated exterior component can be produced in one step with the overmolding of the film heater. In this case, the size of the exterior component is limited only by the size of the injection-molding tool. The exterior component can thus be produced with a structure, the film either being excluded here or being integrated in the structure.

In principle, the abutting edge of the film toward the material will remain at least slightly visible. This can be concealed by a structured surface. To this end, the material in the third step can be correspondingly adapted in order to introduce the structure into the exterior component formed by the material. By way of example, it is possible to introduce a diamond pattern or another pattern which is coordinated such that it incorporates the film edges in the structure, and thus visually conceals them. The pattern can in this case be selected depending on the embodiment of the film, but also depending on design criteria, it also being possible for film edges to be adapted to a predefined design structure, that is to say to assume a particular shape, for example rounded or straight, depending on the type of edge of the predefined structure in the material. It is also advantageous if the color of the heating wires corresponds to the color of the material, that is to say if both of them are black, for example. For this purpose, the heating wires can be colored before being fastened on the film, or after.

Furthermore, provision is made for the material to be a polycarbonate. This material is very well suited for use in the automotive sector, since it has a high strength, stiffness and hardness, and also is a good insulator against electric current and is resistant in relation to water, mineral acids and other substances. Said material is also well suited for injection molding.

Furthermore, provision is made for the sub-region of the vehicle to be one or more regions on which radar components and/or further sensor components to be heated are arranged. In order to ensure the functionality of radar sensors, said sensors need to be heated as efficiently as possible, particularly if they are in danger of being covered, or have already been covered, by snow or ice. Here, rapid de-icing is important, which is made possible by the proposed construction which is realized by way of the production method. Other regions of the vehicle which are provided with sensors or components that must not be covered by snow or ice can also benefit from the method, particularly if they can be produced by means of injection molding.

Other objects, advantages and novel features of the embodiments of the present disclosure will become apparent from the following detailed description of one or more preferred embodiments when considered in conjunction with the accompanying drawings, in which:

### BRIEF DESCRIPTION OF THE DRAWINGS

FIG. 1 is a flow diagram of the inventive method; and

FIG. 2 is a component with connector, produced by way of the inventive method.

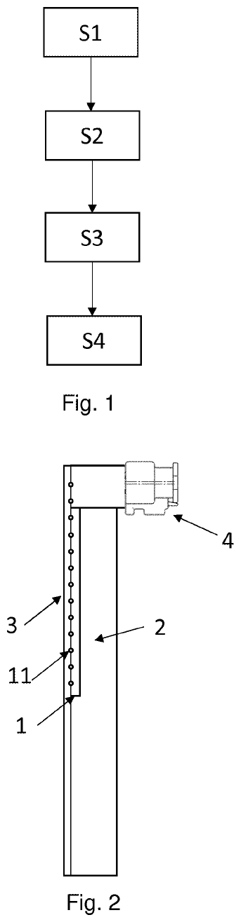

### DETAILED DESCRIPTION OF THE DRAWINGS

In the following descriptions of the figures, identical elements or functions are provided with identical reference designations.

The production method for the above-described surface heater is described below. In a first step S1, a film heater is provided, comprising a film 1 with heating wires 11, which is intended to be used as a heater for, for example, a radar sensor at the front of a vehicle. This film heater can either already be present as a finished component or can be manufactured in a pre-processing step. Here, heating wires 11, which are composed of an electrically conductive material such as copper, are applied, for example adhesively bonded, to a film 1. The process is known to the person skilled in the art. The film 1 with the heating wires 11 is formed to a predefined shape. This shape is for example the shape of a front panel, in particular a kidney panel, of a vehicle. The film heater is thus formed such that it is flush with the surface of the sub-region to be produced of the vehicle, for example of the front panel, or can be arranged thereon.

Before the film heater is inserted into the injection-molding tool in the second step S2, it is advantageous if said heater is cleaned. To this end, corresponding processes are known to the person skilled in the art.

In the second step S2, the formed film heater is inserted into an injection-molding tool. Here, the heating wires 11 can point either toward the wall or into the hollow space of the injection-molding tool.

In the third step S3, an overmolding operation is then performed with a predefined material 2, for example polycarbonate.

In the fourth step S4, a transparent lacquer layer 3 is then applied to the finished injection-molded part.

The thickness of the lacquer layer 3 is selected in the fourth step S4 depending on how the heating wires 11 were inserted into the injection-molding tool in the second step S2.

After the insertion of the film 1 with the heating wires 11 into the injection-molding tool in the second step S2, the overmolding operation is performed with the material 2, for example polycarbonate, in the third step S3. The thickness of the material 2 is selected in such a way that the heating wires 11 are completely embedded in the material 2, for example polycarbonate. This corresponds, for example, to a thickness of the material 2 between 2 mm or 3 mm to 12 mm (in each case inclusive). A thickness of approximately 2 mm, 3 mm, 5 mm, 7 mm or 10 mm is advantageous depending on the type of heating wires 11 and their orientation in the tool.

If the heating wires 11 point toward the wall of the injection-molding tool after insertion into the injection-molding tool in the second step S2, the thickness of the lacquer layer 3 can, on account of the back-molding with the material 2, be somewhat thinner than if the heating wires 11 point into the hollow space of the injection-molding tool after insertion into the injection-molding tool in the second step S2. Depending on the embodiment, the thickness is selected to be between 0.2 mm and 1.0 mm (in each case inclusive), advantageously approximately 0.7 mm.

The thickness of the total layered composite composed of film 1 with heating wires 11, material 2 and lacquer layer 3 advantageously lies between 2 mm and 7 mm inclusive, and is advantageously a multiple of half the wavelength of the radar beams in the material.

The lacquer layer 3 is transparent, such that the underlying material 2 with the film heater is substantially visible. For this reason, it is expedient for the heating wires 11 to be provided in a color which corresponds to the color of the material 2. The heating wires 11 can be colored prior to production of the film heater.

The material of which the lacquer layer 3 is composed is for example PUR or polyurea. This coating above the material 2, for example consisting of polycarbonate, is used to protect the material 2 against UV radiation and other media which would attack the material 2. On account of the low viscosity of the polyurethane, very low layer thicknesses are possible, without large shear forces being applied. This increases the process safety during the overmolding. The film heater with the heating wires 11 can be positioned closer to the surface to be heated, for example a radar sensor, as a result of which the energy requirement is reduced, and the response behavior of the heater is improved. As a result of the subsequent flooding of the film 1, the visible film edges can be concealed, and non-visible integration of a partial heating region in a large component such as a front panel is thus made possible even for transparent materials.

The material used for the lacquer layer 3 should in any case be transparent and suitable for use for the flooding operation, that is to say have a correspondingly suitable viscosity. Alternatively, a spraying operation can also be performed.

For the application of the lacquer layer 3, it is advantageous if the finished injection-molded part, that is to say the produced sub-region of the vehicle with the film heater, remains in the injection-molding tool.

The contact-connection of the heating wires 11 is effected by way of a corresponding connector 4, which can be attached, and contact-connected, to the film heater prior to or after the injection-molding process. The introduction of current heats the heating wires 11 and a defrosting or de-icing operation can be performed.

By means of the proposed method, it is possible to achieve the target of providing a transparent vehicle front which makes it possible to view the exterior component produced from the described material and possibly provided with design elements, but in the case of which the heating wires 11 are not visible (to a detrimental extent) and cannot be felt when touched. This is achieved by the application of the transparent lacquer layer 3. The heating wires 11 have a diameter of approximately 0.05 mm to 0.1 mm, such that the lacquer layer 3 can likewise be selected to be very thin.

The method, for heating a predefined area of a vehicle, in particular a region with a radar sensor, is thus implemented in such a way that a film-based heating element is inserted with the wire side pointing toward the cavity or toward the injection-molding tool in the injection-molding tool, and the film side is subsequently back-molded with a predefined material, for example polycarbonate, in a first shaping process. Subsequently, the cavity is opened, and the composite component composed of film heater and first plastics constituent is assigned to a second cavity, either inside one tool or a further tool is used. Thereafter, a further coating operation is carried out with a transparent polyurethane (PUR). In this case, the coating is flooded over the wire side of the entire component for complete embedding of the film-based heater. In order to conceal any noticeable structures which may still be present through the film 1, more specifically the edges thereof, the material 2 can be produced in a predefined structure which integrates the edges of the film 1 in said structure and thus makes them part of the design.

1.-10. (canceled)

11. A method for producing a surface heater for heating a sub-region of a vehicle, the method comprising:
a first step of arranging heating wires on a film and either: i) the film is subsequently formed to a predefined shape, or ii) providing a film which has been formed to a predefined shape;
a second step of inserting the formed film into an injection-molding tool, wherein the heating wires point either toward the wall or into the hollow space of the injection-molding tool;
a third step of overmolding with a predefined material; and
a fourth step of applying a transparent lacquer layer to the finished injection-molded part.

12. The method according to claim 11, wherein the thickness of the lacquer layer in the fourth step is selected in such a way that the heating wires are completely embedded in the material.

13. The method according to claim 12, wherein the thickness of the total layered composite composed of film with heating wires, material and lacquer layer is between 2 mm and 7 mm inclusive, and is a multiple of half the wavelength of the radar beams in the material.

14. The method according to claim 13, wherein the lacquer layer has a thickness of between 0.2 mm and 1.0 mm.

15. The method according to claim 14, wherein the lacquer layer is applied in the tool via flooding.

16. The method according to claim 15, wherein the formed film occupies a sub-region of the injection-molding tool.

17. The method according to claim 16, wherein the heating wires are colored at least in sub-regions, over the entire area, in the color of the material.

18. The method according to claim 17, wherein, in the third step, the overmolding is performed with the predefined material in such a way that a structured surface with a predefined structure is generated.

19. The method according to claim 18, wherein the material is a polycarbonate.

20. The method according to claim 19, wherein the sub-region of the vehicle is one or more regions on which radar components and/or further sensor components to be heated are arranged.
